(19) United States
(12) Patent Application Publication
(10) Pub. No.: US 2013/0210267 A1
(43) Pub. Date: Aug. 15, 2013

(54) CONNECTOR

(71) Applicants: WEI-DONG CONG, Shenzhen City (CN); LEI LIU, Shenzhen City (CN)

(72) Inventors: WEI-DONG CONG, Shenzhen City (CN); LEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/403,932

(22) Filed: Feb. 23, 2012

(30) Foreign Application Priority Data
Feb. 10, 2012 (CN) 201210029549.4

(51) Int. Cl. H01R 13/56

(52) U.S. Cl. 439/445

(57) ABSTRACT

A connector includes a block, a connector body formed on a bottom surface of the block, and a number of cables connected to the connector body and extending through a top surface of the block. A binding member includes a plate extending out from the block and a binding portion extending from the plate. A distal end of the binding portion is detachably engaged with the plate, thereby binding the cables between the plate and the binding portion.

### BACKGROUND

1. Technical Field

The present disclosure relates to a connector.

2. Description of Related Art

Connectors for a computer or a server are connected to cables and electrically connected to other components. However, the cables adjacent to the connectors usually need to be pressed down or constrained in order to assemble binding portions or other structures to enclose the components, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a connector.

FIG. 2 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

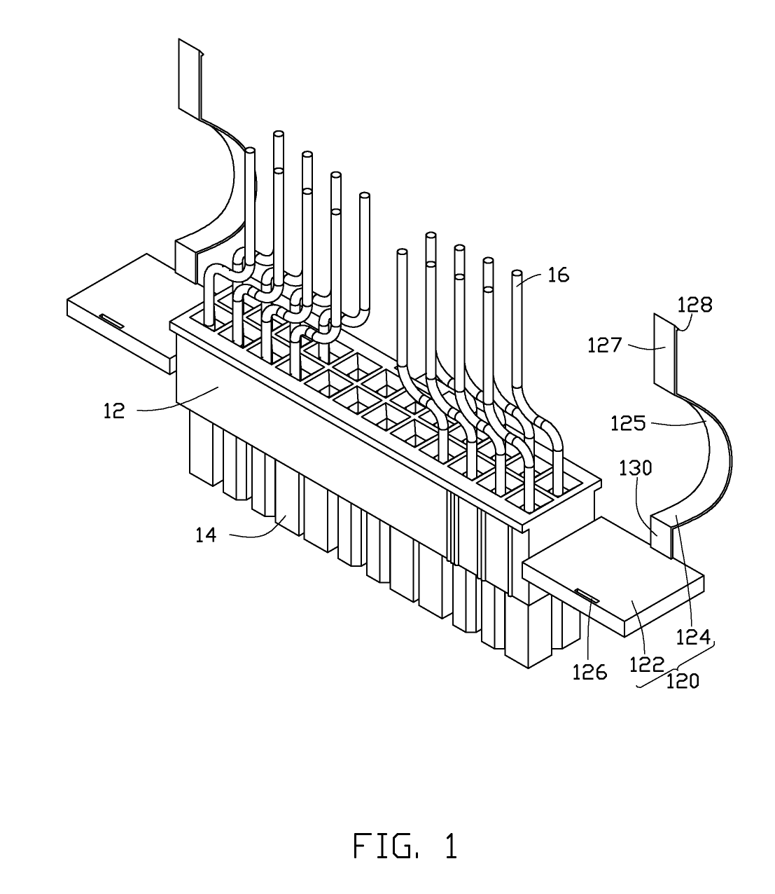

Referring to FIG. 1, an exemplary embodiment of a connector includes a rectangular block 12, a connector body 14 formed on a bottom surface of the block 12, and a plurality of cables 16 connected to the connector body 14 and extending through a top surface of the block 12.

A binding member 120 is formed on each of opposite ends of the block 12. The binding member 120 includes a plate 122 extending out from the end of the block 12, and a deformable binding portion 124 extending from a rear side of the plate 122. An engaging hole 126 is defined in the plate 122, adjacent to a front side of the plate 122 opposite to the rear side, and extending through a top surface and a bottom surface of the plate 122. The binding portion 124 includes a connection piece 130 extending from the rear side of the plate 122, a substantially C-shaped main body 125 extending from a distal end of the connection piece 130 opposite to the plate 122, and an engaging piece 127 extending from a distal end of the main body 125 opposite to the connection piece 130. A substantially wedge-shaped protrusion 128 is formed on a rear surface of a distal end of the engaging piece 127 opposite to the main body 125.

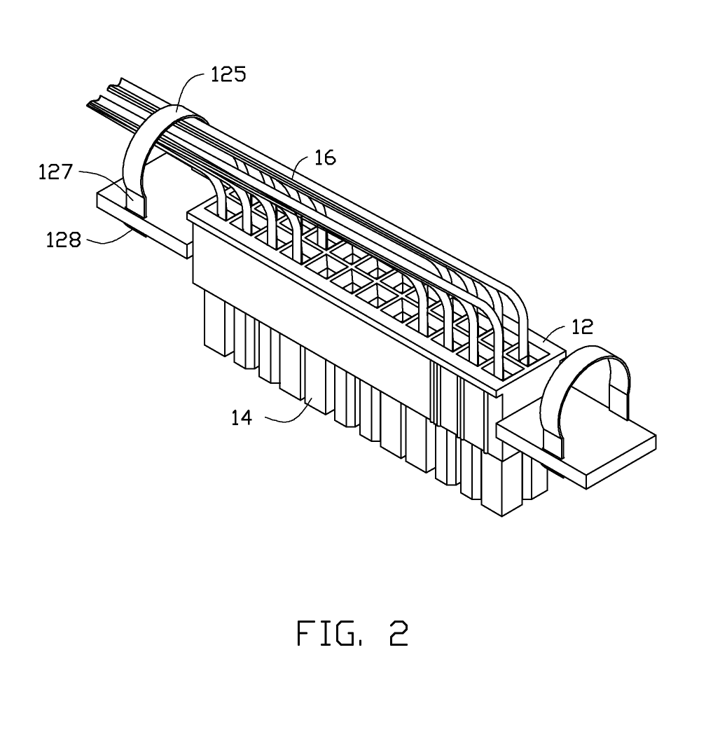

Referring to FIG. 2, in use, the cables 16 are pressed toward the top surface of the plate 122 of one of the binding members 120. The binding portion 124 is deformed toward the engaging hole 126. The cables 16 are limited between the main body 125 and the plate 122. The protrusion 128 extends through the engaging hole 126 to be blocked by the bottom surface of the plate 122.

In releasing the cables 16, the protrusion 128 is disengaged from the engaging hole 126, thereby, the binding portion 124 releases the cables 16.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A connector, comprising:
a block;
a connector body extending from a bottom surface of the block;
a plurality of cables connected to the connector body and extending through a top surface of the block opposite to the bottom surface; and
a binding member comprising a plate extending out from the block, and a binding portion extending from the plate, a distal end of the binding portion detachably engaged with the plate, and binding the cables between the binding portion and the plate.

2. The connector of claim 1, wherein the binding portion extends from a first side of the plate, the plate defines an engaging hole in a second side of the plate, a protrusion extends from the distal end of the binding portion to engage in the engaging hole.

3. The connector of claim 2, wherein the binding portion is deformable, the protrusion is substantially wedge-shaped.
